(19) United States
(12) Patent Application Publication
(10) Pub. No.: US 2020/0233247 A1
(43) Pub. Date: Jul. 23, 2020

(54) DISPLAY PANEL WITH ENHANCED WATERPROOF ABILITY

(71) Applicant: WUHAN CHINA STAR OPTOELECTRONICS TECHNOLOGY CO., LTD., Wuhan (CN)

(72) Inventors: CHAOJUN ZHAO, WUHAN (CN); FEI AL, WUHAN (CN); SHIYU LONG, WUHAN (CN)

(21) Appl. No.: 16/487,586

(22) PCT Filed: Feb. 26, 2019
(86) PCT No.: PCT/CN2019/076176

§ 371 Date: Aug. 21, 2019

(30) Foreign Application Priority Data
Dec. 21, 2018 (CN) 201811569188.6

(51) Int. Cl. G02F 1/1339; G02F 1/1362; G02F 1/1368; G02F 1/1335

(52) U.S. Cl. CPC G02F 1/1339; G02F 1/136209; G02F 2001/133357; G02F 1/133514; G02F 1/1368

(57) ABSTRACT

A display panel with enhanced waterproof ability is disclosed and includes a thin film transistor glass substrate, a color filter glass substrate, a frame sealing layer, and a liquid crystal layer. The color filter glass substrate is opposite to the thin film transistor glass substrate. The frame sealing layer and liquid crystal layer are disposed between the thin film transistor glass substrate and the color filter glass substrate. A planarization layer and a passivation layer are sequentially stacked on a surface of the thin film transistor glass substrate facing the frame sealing layer. An outer periphery of the planarization layer adjacent to the narrow bezel display panel is defined with a waterproof groove. The passivation layer extends to a portion adjacent to the waterproof groove without extending into the waterproof groove. Outer peripheries of the passivation layer and the display panel are at an interval to improve waterproof ability.

### FIELD OF INVENTION

The present invention relates to a display panel, especially to a display panel with enhanced waterproof ability that is able to lower risk of water vapor invasion resulting in damage of a display panel.

### BACKGROUND OF INVENTION

As time goes by, liquid crystal display panel technologies develop faster and pursue resolutions with high pixels per inch (PPI) and narrow bezels. At present, narrow bezel technology has been extensively applied to display panels.

With reference to FIG. 1, FIG. 1 is a partially enlarged cross-sectional top view of a conventional 0.7 mm narrow bezel display panel. The narrow bezel display panel includes a thin film transistor glass substrate 91, a color filter glass substrate 92, a frame sealing layer 93, and a liquid crystal layer. the thin film transistor glass substrate 91 and the color filter glass substrate 92 are disposed opposite to each other. The frame sealing layer 93 is disposed between the thin film transistor glass substrate 91 and the color filter glass substrate 92, is located on an outer periphery of the thin film transistor glass substrate 91, and is located on an outer periphery of the color filter glass substrate 92. The liquid crystal layer is filled among the thin film transistor glass substrate 91, the color filter glass substrate 92, and the frame sealing layer 93.

A planarization (PLN) layer 911, a passivation layer 913, and a polyimide layer 915 are sequentially stacked on a surface of the thin film transistor glass substrate 91 facing the color filter. A groove 9110 is defined in an outer periphery 905 of the planarization layer 911 close to the narrow bezel display panel. The passivation layer 913 extends to the groove 9110 and is located adjacent to an edge 905 of the narrow bezel display panel.

A black matrix 921, a covering layer 922, and a polyimide layer 923 are sequentially stacked on a surface of the color filter glass substrate 92 facing the thin film transistor glass substrate 91. Furthermore, a displaying region 925 is formed on the color filter glass substrate 92.

A design of the groove 9110 of the planarization layer 911 of the narrow bezel display panel isolates the planarization layer 911 from external environment and lowers a risk of water vapor invasion into an internal of the display panel. However, the passivation layer 913 in the groove 9110 of the planarization layer 911, because of influence of the process, is formed into a film only on a temperature over 200 degrees Celsius (° C.) and has a loose film density such that the film easily becomes a channel through which water vapor invasion to the internal of the display panel. Therefore, products of the conventional 0.7 mm narrow bezel display panel have a poor waterproof ability.

Therefore, it is necessary to provide a display panel with enhanced waterproof ability to solve the existing issue of the prior art.

### SUMMARY OF INVENTION

### Technical Issue

Because a conventional display panel has a technical issue that a groove of a planarization layer on an edge of a narrow bezel is disposed with a passivation layer easily invaded by water vapor, the present invention provides a display panel with enhanced waterproof ability to solve the technical issue.

### Technical Solution

A main objective of the present invention is to provide a display panel with enhanced waterproof ability, comprising:

a thin film transistor glass substrate;

a color filter glass substrate, disposed opposite to the thin film transistor glass substrate;

a frame sealing layer, disposed between the thin film transistor glass substrate and the color filter glass substrate, located on an outer periphery of the thin film transistor glass substrate, and located on an outer periphery of the color filter glass substrate; and

a liquid crystal layer, filled between the thin film transistor glass substrate, the color filter glass substrate, and the frame sealing layer;

wherein a planarization layer and a passivation layer are sequentially stacked on a surface of the thin film transistor glass substrate facing the frame sealing layer, a waterproof groove is defined in an outer periphery of the planarization layer adjacent to the narrow bezel display panel, the passivation layer extends to a portion adjacent to the waterproof groove without extending into the waterproof groove, and an outer periphery of the passivation layer and an outer periphery of the display panel are at an interval.

In an embodiment of the present invention, an outer periphery of the passivation layer extends to an edge of the waterproof groove.

In an embodiment of the present invention, the outer periphery of the passivation layer is flush with an edge of the waterproof groove.

In an embodiment of the present invention, the interval between the outer periphery of the passivation layer and the outer periphery of the display panel is filled with a frame sealant such that the frame sealant filled is located between the outer periphery of the passivation layer and the outer periphery of the display panel.

In an embodiment of the present invention, a first polyimide layer is stacked on the passivation layer. a black matrix, a covering layer, and a second polyimide layer are sequentially stacked on a surface of the color filter glass substrate facing the thin film transistor glass substrate.

Another objective of the present invention is to provide a display panel with enhanced waterproof ability, comprising:

a thin film transistor glass substrate;

a color filter glass substrate, disposed opposite to the thin film transistor glass substrate;

a frame sealing layer, disposed between the thin film transistor glass substrate and the color filter glass substrate, located on an outer periphery of the thin film transistor glass substrate, and located on an outer periphery of the color filter glass substrate; and

a liquid crystal layer, filled between the thin film transistor glass substrate, the color filter glass substrate, and the frame sealing layer;

wherein a planarization layer and a passivation layer are sequentially stacked on a surface of the thin film transistor glass substrate facing the frame sealing layer, a waterproof groove is defined in an outer periphery of the planarization layer adjacent to the narrow bezel display panel, the passivation layer extends to a portion adjacent to the waterproof groove without extending into the waterproof groove, and an outer periphery of the passivation layer and an outer periphery of the display panel are at an interval;

wherein an outer periphery of the passivation layer extends to an edge of the waterproof groove;

wherein the outer periphery of the passivation layer is flush with an edge of the waterproof groove;

wherein the interval between the outer periphery of the passivation layer and the outer periphery of the display panel is filled with a frame sealant such that the frame sealant filled is located between the outer periphery of the passivation layer and the outer periphery of the display panel.

In an embodiment of the present invention, the interval between the outer periphery of the passivation layer and the outer periphery of the display panel is filled with a frame sealant such that the frame sealant filled is located between the outer periphery of the passivation layer and the outer periphery of the display panel.

In an embodiment of the present invention, a first polyimide layer is stacked on the passivation layer.

In an embodiment of the present invention, a black matrix, a covering layer, and a second polyimide layer are sequentially stacked on a surface of the color filter glass substrate facing the thin film transistor glass substrate.

Advantages

Compared to the prior art, the display panel with enhanced waterproof ability of the present invention, by an etching process, removes a portion of the passivation layer in the waterproof groove of the planarization layer to prevent the outer periphery of the passivation layer with loose material adjacent to the display panel from direct invasion of external water vapor such that the external water vapor is isolated from the passivation layer to further prevent the water vapor from entering the channel in display panel, which lowers the risk of damage of the display panel due to water vapor invasion.

In an embodiment of the present invention, a displaying region is formed on the color filter glass substrate.

In order to make the above contents of the present invention clearer and more understandable, detailed descriptions of preferred embodiments in conjunction with the drawings will be presented as follows.

### DESCRIPTION OF DRAWINGS

FIG. 1 is a partially enlarged cross-sectional top view of a conventional 0.7 mm narrow bezel display panel.

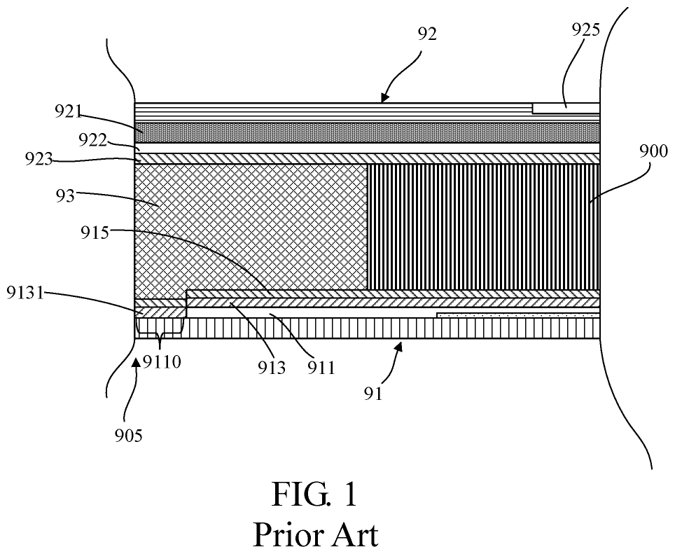

FIG. 2 is a front view of a display panel with enhanced waterproof ability of the present invention.

FIG. 3 is a partially enlarged cross-sectional top view of the display panel with enhanced waterproof ability of the present invention.

### DETAILED DESCRIPTION OF PREFERRED EMBODIMENTS

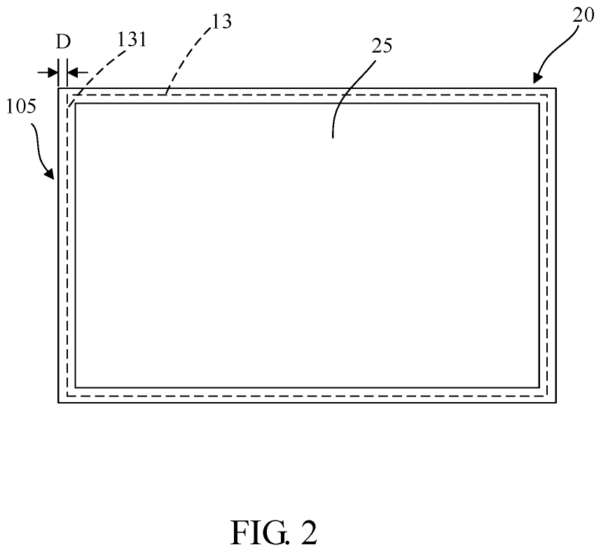

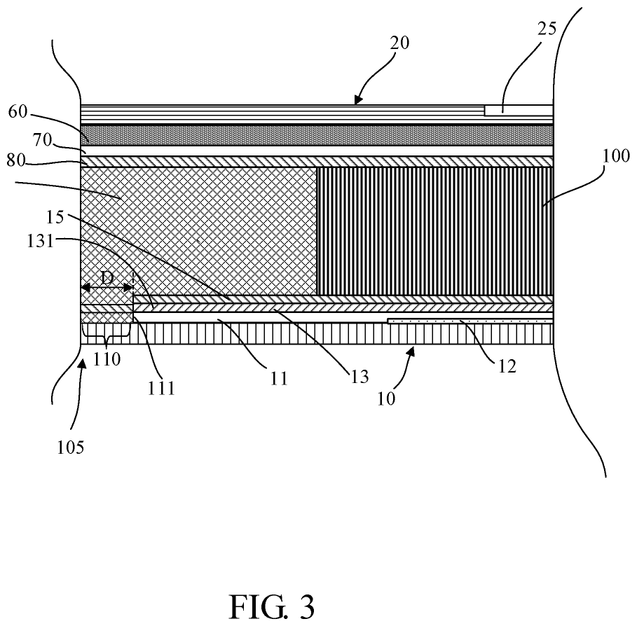

With reference to FIGS. 2 and 3, FIG. 2 is a front view of a display panel with enhanced waterproof ability of the present invention. FIG. 3 is a partially enlarged cross-sectional top view of the display panel with enhanced waterproof ability of the present invention. the present invention display panel with enhanced waterproof ability, includes a thin film transistor glass substrate 10, a color filter glass substrate 20, a frame sealing layer 30, and a liquid crystal layer 100.

The color filter glass substrate 20 are disposed opposite to the thin film transistor glass substrate 10. In a preferred embodiment of the present invention, a displaying region 25 is formed on the color filter glass substrate 20.

The frame sealing layer 30 is disposed between the thin film transistor glass substrate 10 and the color filter glass substrate 20, is located on an outer periphery of the thin film transistor glass substrate 10, and is located on an outer periphery of the color filter glass substrate 20.

The liquid crystal layer 100 is filled between the thin film transistor glass substrate 10, the color filter glass substrate 20, and the frame sealing layer 30.

A planarization layer 11 and a passivation layer 13 are disposed on a surface of the thin film transistor glass substrate 10 facing the frame sealing layer 30. A waterproof groove 110 is defined in an outer periphery 105 of the planarization layer 11 adjacent to the narrow bezel display panel. the passivation layer 13 extends to a portion adjacent to the waterproof groove 110 without extending into the waterproof groove 110. An outer periphery of the passivation layer 13 and the outer periphery 105 of the display panel are at an interval D. In a preferred embodiment of the present invention, the outer periphery of the passivation layer 13 extends to an edge 111 of the waterproof groove 110. In a preferred embodiment of the present invention, the outer periphery of the passivation layer 13 is flush with the edge 111 of the waterproof groove 110. In a preferred embodiment of the present invention, the interval D between the outer periphery of the passivation layer 13 and the outer periphery 105 of the display panel is filled with a frame sealant such that the filled frame sealant is located between the outer periphery of the passivation layer 13 and the outer periphery 105 of the display panel. In a preferred embodiment of the present invention, a first polyimide layer is stacked on the passivation layer 13. In a preferred embodiment of the present invention, a gate driver on array (GOA) circuit 12 is formed between the planarization layer 11 and the thin film transistor glass substrate 10.

In a preferred embodiment of the present invention, a black matrix 60, a covering layer 70, and a second polyimide layer 80 are sequentially formed on a surface of the color filter glass substrate 20 facing the thin film transistor glass substrate 10.

Compared to the prior art, the display panel with enhanced waterproof ability of the present invention, by an etching process, removes a portion of the passivation layer 13 in the waterproof groove 110 of the planarization layer 11 to prevent the outer periphery 105 of the passivation layer 13 with loose material adjacent to the display panel from direct invasion of external water vapor such that the external water vapor is isolated from the passivation layer 13 to further prevent the water vapor from entering the channel in display panel, which lowers the risk of damage of the display panel due to water vapor invasion.

What is claimed is:

1. A display panel with enhanced waterproof ability, comprising:
a thin film transistor glass substrate;
a color filter glass substrate, disposed opposite to the thin film transistor glass substrate;
a frame sealing layer, disposed between the thin film transistor glass substrate and the color filter glass substrate, located on an outer periphery of the thin film transistor glass substrate, and located on an outer periphery of the color filter glass substrate; and
a liquid crystal layer, filled between the thin film transistor glass substrate, the color filter glass substrate, and the frame sealing layer;
wherein a planarization layer and a passivation layer are sequentially stacked on a surface of the thin film transistor glass substrate facing the frame sealing layer, a waterproof groove is defined in an outer periphery of the planarization layer adjacent to the narrow bezel display panel, the passivation layer extends to a portion adjacent to the waterproof groove without extending into the waterproof groove, and an outer periphery of the passivation layer and an outer periphery of the display panel are at an interval.

2. The display panel with enhanced waterproof ability as claimed in claim 1, wherein an outer periphery of the passivation layer extends to an edge of the waterproof groove.

3. The display panel with enhanced waterproof ability as claimed in claim 1, wherein the outer periphery of the passivation layer is flush with an edge of the waterproof groove.

4. The display panel with enhanced waterproof ability as claimed in claim 1, wherein the interval between the outer periphery of the passivation layer and the outer periphery of the display panel is filled with a frame sealant such that the frame sealant filled is located between the outer periphery of the passivation layer and the outer periphery of the display panel.

5. The display panel with enhanced waterproof ability as claimed in claim 2, wherein the interval between the outer periphery of the passivation layer and the outer periphery of the display panel is filled with a frame sealant such that the frame sealant filled is located between the outer periphery of the passivation layer and the outer periphery of the display panel.

6. The display panel with enhanced waterproof ability as claimed in claim 3, wherein the interval between the outer periphery of the passivation layer and the outer periphery of the display panel is filled with a frame sealant such that the frame sealant filled is located between the outer periphery of the passivation layer and the outer periphery of the display panel.

7. The display panel with enhanced waterproof ability as claimed in claim 1, wherein a first polyimide layer is stacked on the passivation layer.

8. The display panel with enhanced waterproof ability as claimed in claim 1, wherein a black matrix, a covering layer, and a second polyimide layer are sequentially stacked on a surface of the color filter glass substrate facing the thin film transistor glass substrate.

9. A display panel with enhanced waterproof ability, comprising:
a thin film transistor glass substrate;
a color filter glass substrate, disposed opposite to the thin film transistor glass substrate;
a frame sealing layer, disposed between the thin film transistor glass substrate and the color filter glass substrate, located on an outer periphery of the thin film transistor glass substrate, and located on an outer periphery of the color filter glass substrate; and
a liquid crystal layer, filled between the thin film transistor glass substrate, the color filter glass substrate, and the frame sealing layer;
wherein a planarization layer and a passivation layer are sequentially stacked on a surface of the thin film transistor glass substrate facing the frame sealing layer, a waterproof groove is defined in an outer periphery of the planarization layer adjacent to the narrow bezel display panel, the passivation layer extends to a portion adjacent to the waterproof groove without extending into the waterproof groove, and an outer periphery of the passivation layer and an outer periphery of the display panel are at an interval;
wherein an outer periphery of the passivation layer extends to an edge of the waterproof groove;
wherein the outer periphery of the passivation layer is flush with an edge of the waterproof groove;
wherein the interval between the outer periphery of the passivation layer and the outer periphery of the display panel is filled with a frame sealant such that the frame sealant filled is located between the outer periphery of the passivation layer and the outer periphery of the display panel.

10. The display panel with enhanced waterproof ability as claimed in claim 9, wherein the interval between the outer periphery of the passivation layer and the outer periphery of the display panel is filled with a frame sealant such that the frame sealant filled is located between the outer periphery of the passivation layer and the outer periphery of the display panel.

11. The display panel with enhanced waterproof ability as claimed in claim 9, wherein a first polyimide layer is stacked on the passivation layer.

12. The display panel with enhanced waterproof ability as claimed in claim 9, wherein a black matrix, a covering layer, and a second polyimide layer are sequentially stacked on a surface of the color filter glass substrate facing the thin film transistor glass substrate.
